(19) United States
(12) Patent Application Publication
(10) Pub. No.: US 2004/0261621 A1
(43) Pub. Date: Dec. 30, 2004

(54) DISPOSABLE FILTERING AND MUFFLING ASSEMBLY

(76) Inventor: William S. Lindsay, Jupiter, FL (US)

Correspondence Address: STITES & HARBISON PLLC, 1199 NORTH FAIRFAX STREET, SUITE 900, ALEXANDRIA, VA, 22314, US

(21) Appl. No.: 10/606,220

(22) Filed: Jun. 26, 2003

(51) Int. Cl. B01D 46/00

(52) U.S. Cl. 96/388; 55/385.3

(57) ABSTRACT

A disposable assembly for filtering air drawn into an air intake and for muffling noise exiting from the air intake is provided. The assembly includes a unitary cylindrical housing having air inlet apertures at a proximal end thereof and a longitudinal filter assembly disposed therein. This filter assembly includes a hollow filter element having an air inlet side which is adjacent but spaced from the lateral enclosure of the housing and an air outlet side opposite thereto with an air impermeable silencing member disposed adjacent the air outlet side. This silencing member includes a plurality of discrete air holes therein and forms a second acoustic chamber interiorly thereof. A coupling member at the housing proximal end removably attaches the assembly to the air intake. The various chambers in the assembly as well as the silencing member and filter serve to dampen the noise.

### BACKGROUND OF THE INVENTION

As air compressors or other machines draw air thereinto, noise generated by the machine easily exits from the air intake of the machine. Particularly in the case of air compressors where the generated noise is created by the reciprocating action(s) of piston(s) and/or valves, the noise can be excessive or at least disturbing. In the prior art, noise suppression has been accomplished by the use of silencing tubes installed in the base or on the cover/hood of the machine. However, such silencing tubes were not very efficient in reducing noise.

Attempts have also been made to combine muffling of noise from an air intake with air filtering of the air drawn in by the air intake. Examples of such systems are shown in U.S. Pat. No. 4,089,663 (Kulig et al.) and U.S. Pat. No. 2,050,581 (Orem). However, such systems have not been satisfactory in dampening noise for machines creating a lot of noise.

### BRIEF SUMMARY OF THE INVENTION

In accordance with the present invention, a disposable assembly for filtering air drawn into an air intake of an air compressor or like machine and for muffling compressor or machine noise exiting from the compressor air intake is provided. The assembly includes a longitudinal and preferably unitary cylindrical housing. This housing includes an air impermeable lateral enclosure, an air impermeable housing proximal end closing a proximal end of the lateral enclosure and having air inlet apertures therein, and an air impermeable housing distal end closing a distal end of the lateral enclosure.

The assembly also includes a longitudinal filter assembly disposed in the housing. This filter assembly includes a hollow filter element disposed between the housing proximal end and the housing distal end. The filter element includes an air inlet side which is adjacent but spaced from the lateral enclosure so as to form a first acoustic chamber therebetween. Air passing through the air inlet apertures of the housing proximal end is received in the first acoustic chamber before being filtered by passing through the filter element. The filter element also includes an air outlet side opposite to the air inlet side.

The assembly further includes an air impermeable silencing member disposed inside of the filter element adjacent the air outlet (interior) side and axially along a length thereof. This silencing member includes a plurality of discrete air holes therein, and forms a second acoustic chamber interiorly thereof. A coupling member at the proximal end of the housing is also provided by which the housing and hence the assembly is removably and hence disposably attached to the compressor air intake and through which air drawn into the second acoustic chamber is then drawn into the compressor air intake.

With this construction, as air is drawn into the compressor air intake, compressor noise issuing from the compressor air intake is dampened at least in the following ways: (a) in the second acoustic chamber, as only some compressor noise passes through the air holes of the silencing member, (b) by passage through the filter element from the second acoustic chamber, (c) after exiting from the filter element into the first acoustic chamber and bouncing off of the lateral enclosure of the housing, by reception by the filter element, and (d) by restricted passage through the air inlet apertures.

In a preferred embodiment of the invention, the air inlet apertures are located laterally interior of the first acoustic chamber. In addition, the filter assembly further includes an air impermeable filter proximal end adjacent the housing proximal end; and a spacer element which spaces the filter proximal end longitudinally away from the housing proximal end so as to form an air inlet chamber immediately adjacent the air inlet apertures. Thus, the compressor noise is also dampened in this air inlet chamber. Preferably, the air inlet apertures are tuned to the inlet side of the filter element to better dampen the noise.

In the preferred embodiment, the filter assembly further includes an air impermeable filter distal end adjacent the housing distal end. In addition, a spring member located between the filter distal end and the housing distal end holds the filter assembly resiliently in place in the longitudinal housing. This spring member also forms a third acoustic chamber between the filter distal end and the housing distal end in which compressor noise is dampened, and dampens compressor noise transmitted through the filter distal end to the housing distal end.

Also in the preferred embodiment, the filter assembly includes a single, hollow, cylindrical filter element, and the first acoustic chamber and the second acoustic chamber are filled only with air. The hollow filter element is then preferably a pleated filter.

Further in the preferred embodiment, the coupling member is a hollow screw nipple. This screw nipple includes a threaded section which is threadably received by the compressor air intake in order to make the longitudinal housing removable and disposable. In addition, the lateral enclosure, the hollow filter element, and the silencing member all have a circular longitudinal cross section.

Still further in the preferred embodiment, the air holes form less than 25% of a surface area of the silencing member. In addition, the lateral enclosure, the housing proximal end and the housing distal end are permanently secured to one another to form a unitary longitudinal housing in which the filter assembly and the silencing member are disposed.

It is an advantage of the present invention that a disposable assembly is provided which adequately muffles machine noise exiting from an air intake while providing good filtering of air drawn into the air intake by the machine.

It is also an advantage of the present invention that the disposable assembly is quickly and easily changed for a new disposable assembly when the filter needs to be changed.

It is a further advantage of the present invention that the disposable assembly is easy and cheap to construct.

Other features and advantages of the present invention are stated in or apparent from detailed descriptions of presently preferred embodiments of the invention found hereinbelow.

### BRIEF DESCRIPTION OF THE SEVERAL VIEWS OF THE DRAWINGS

FIG. 1 is an elevation view in partial cross section of the filtering and muffling assembly of the present invention.

FIG. 2 is a bottom view of the assembly depicted in FIG. 1, with the section line 1-1 showing the section of FIG. 1.

### DETAILED DESCRIPTION OF THE INVENTION

With reference now to the drawings in which like numerals represent like elements throughout the two views, a disposable filtering and muffling assembly 10 which is attached to an air intake 12 (shown in a chained line) of a compressor or the like air consuming machine is depicted in the drawings. It will be appreciated that air consuming machines of this type typically produce loud and sharp noises, which noises are caused by the inherent operation of the pistons and valves of the machine and which noises readily exit through the air inlet path associated with air intake 12.

Disposable assembly 10 includes a longitudinal housing 14 which is preferably cylindrically shaped as typical of filters in the art. Housing 14 includes an air impermeable lateral enclosure or cylindrical wall 16 and an air impermeable distal end 18. Distal end 18 is preferably integrally formed with cylindrical wall 16 to provide a simple air tight closure.

Opposite to distal end 18 is an air impermeable proximal end 20. Proximal end 20 includes a flange member 22 whose outer peripheral edge is rolled together with the proximal end of cylindrical wall 16 as shown to permanently attach flange member 22 to cylindrical wall 16 and ultimately to form housing 14 as a unitary enclosure. Proximal end 20 also includes a base member 26 which is attached to flange member 22 by a series of pressure welds 24 or the like. Base member 26 includes air inlet apertures 28 provided therethrough by which ambient air is first introduced into housing 14.

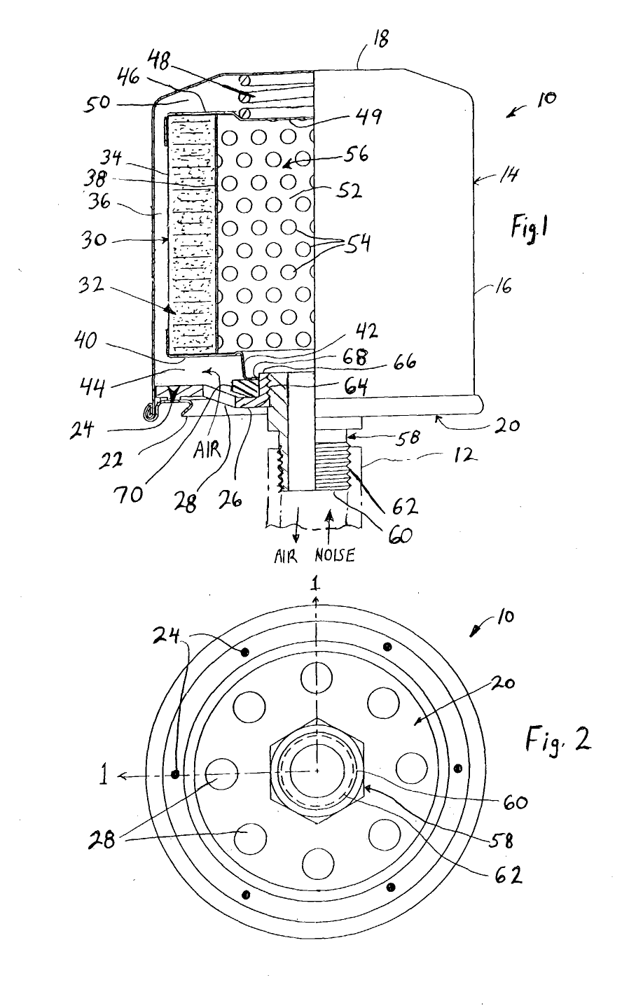

Disposed in housing 14 between proximal end 20 and distal end 18 is a longitudinal filter assembly 30 which is preferably cylindrically shaped as typical in the art. Filter assembly 30 includes a single (preferably) cylindrical hollow filter element 32 which is disposed between housing proximal end 20 and housing distal end 18. Filter element 32 is conveniently a paper pleated filter, but filter element 32 could also be made of other air filtering materials and constructions as well known in the art. Filter element 32 includes an air inlet side 34 which is adjacent but spaced from cylindrical wall 16 so as to form a first acoustic chamber 36 therebetween and into which air passing through air inlet apertures 28 is received before being filtered by passing through filter element 32. It will be appreciated that air inlet apertures 34 are located laterally interior of first acoustic chamber 36 as shown in FIG. 1. Opposite (interiorly) to air inlet side 34 is an air outlet side 38 of filter element 32.

Filter assembly 30 also includes an air impermeable filter proximal end 40 adjacent housing proximal end 20. A spacer element 42 is used to space filter proximal end 40 longitudinally away from housing proximal end 20 so as to form an air inlet chamber 44 immediately adjacent air inlet apertures 28. Conveniently, space element 42 is press formed integrally with the remainder of filter proximal end 40 as shown in FIG. 1. Opposite to filter proximal end 40 is an air impermeable filter distal end 46 adjacent housing distal end 18. It will be appreciated that both filter proximal end 40 and filter distal end 46 are preferably permanently secured to filter element 32, as by gluing or the like.

Filter assembly 30 further includes a spring member 48. located between filter distal end 46 and housing distal end 18. Spring member 48 is used to hold filter element 32 resiliently in place longitudinally inside of housing 14, as well as centered adjacent housing distal end 18 by engagement with depression 49 in filter distal end 46. While a coiled spring is depicted as forming spring member 48 in FIG. 1, it will be appreciated that other forms of spring member 48 are possible which still serve both functions. For example, the spring member could be a flat spring which is slightly bowed in the middle and which has depending edges to trap corresponding lateral edges of filter element 32 therebetween. It will also be appreciated that spring member 48 serves to form a distal acoustic chamber 50 between filter distal end 46 and housing distal end 18.

Disposed inside of filter element 32 is an air impermeable silencing member 52. Silencing member 52 is located immediately adjacent air outlet side 38 and axially along the entire length thereof. Conveniently, silencing member 52 is secured to air outlet side 38 and, following the shape of air outlet side 38, silencing member 52 is cylindrically shaped by rolling a flat rectangular piece of metal into a cylinder. Silencing member 52 includes a plurality of discrete air holes 54 therein, and forms a second acoustic chamber 56 interiorly thereof which is filled only with air. Air holes 54 form less than about 25% of a surface area of the silencing member in order to serve the needed damping or muffling function (as explained below).

A coupling member 58 at housing proximal end 20 is provided by which housing 14 is removably attached to compressor air intake 12. It will be appreciated that it is through coupling member 58 that air drawn is drawn directly into compressor air intake 12 from second acoustic chamber 56. Conveniently, coupling member 58 is a hollow screw nipple 60 including a threaded section 62 which is threadably received by compressor air intake 12 in order to make longitudinal housing 14 and hence assembly 10 itself removable and disposable. Screw nipple 60 is preferably attached to base member 26 by use of a threaded section 64 integrally formed thereon which is received in a similarly threaded extension 66 of base member 26. With this construction, and in order to center filter proximal end 40 in housing 14, threaded section 66 of screw nipple 60 extends into an only slightly larger aperture 68 provided centrally in spacer element 42. Then, to provide an airtight fit between screw nipple 60 and spacer element 42, a seal 70 is disposed therebetween such that spring member 48 holds screw nipple 60 and spacer element sealing against seal 70.

In operation of filtering and muffling assembly 10, air is drawn into assembly 10 by the vacuum created at air intake 12 by the compressor or the like. The air path through assembly 10 begins where air is initially drawn into air inlet chamber 44 of housing 14 through air inlet apertures 28 in housing proximal end 20. After entering air inlet chamber 44, the air is drawn from air inlet chamber 44 to first acoustic chamber 36. From first acoustic chamber 44, the air is then drawn through filter element 32 which performs the filtering of the air required, and then through holes 54 of silencing member 52 into second acoustic chamber 56. From second acoustic chamber 56, the air is then drawn longitudinally through coupling member 58 and into air intake 12.

As the movement of the air takes place, it will be appreciated that noise (acoustic waves) are generated by the compressor or the like and issue from air intake 12 directly into assembly 10 through coupling member 58. This noise is then muffled or dampened by assembly 10 in the following manners. Initially, the compressor noise entering assembly 10 is dampened in second acoustic chamber 56, as only some compressor noise passes through air holes 54 of silencing member 52. Then, the noise which does pass through air holes 54 is further dampened by passage through filter element 32. Next, the remaining noise exiting from filter element 32 into the first acoustic chamber 36 is dampened as the noise bounces off of cylindrical wall 16 of housing 14 for subsequent reception by filter element 32. Finally, that noise issuing from first acoustic chamber 36 passes into air inlet chamber 44 where the noise is further dampened as only some of that noise finally exits assembly 10 by passage out of air inlet apertures 28. As noted above, air inlet apertures 28 are located laterally interior of first acoustic chamber 36. This is the location which has been determined as the best “tuned” location for the air apertures to best reduce noise. Typically, such tuning is the result of trial and error, but however the tuning location and associated factors are determined, it will be appreciated that the position and size of air inlet apertures 28 should be so tuned to achieve the best noise reduction without retarding air flow.

It will also be appreciated that distal acoustic chamber 50 located between filter distal end 46 and housing distal end 18 also serves to dampen any compressor noise transmitted thereto. In addition, spring member 48 also dampens compressor noise transmitted through filter distal end 46 due to the resiliency of spring member 48.

While the present invention has been described with respect to exemplary embodiments thereof, it will be understood by those of ordinary skill in the art that variations and modifications can be effected within the scope and spirit of the invention.

I claim:

1. A disposable assembly for filtering air drawn into a compressor air intake of an air compressor and for muffling compressor noise exiting from the compressor air intake, said assembly comprising:
a longitudinal housing including
an air impermeable lateral enclosure,
an air impermeable housing proximal end closing a proximal end of said lateral enclosure and having air inlet apertures therein, and
an air impermeable housing distal end closing a distal end of said lateral enclosure;
a longitudinal filter assembly disposed in said housing, said filter assembly including a hollow filter element and disposed between said housing proximal end and said housing distal end, said filter element including
an air inlet side which is adjacent but spaced from said lateral enclosure so as to form a first acoustic chamber therebetween into which air passing through said air inlet apertures of said housing proximal end is received before being filtered by passing through said filter element, and
(b) an air outlet side opposite to said air inlet side;
an air impermeable silencing member disposed inside of said filter element adjacent said air outlet side and axially along a length thereof, said silencing member including a plurality of discrete air holes therein and forming a second acoustic chamber interiorly thereof; and
a coupling member at the proximal end of said housing by which said housing is removably attached to the compressor air intake and through which air drawn into said second acoustic chamber is then drawn into the compressor air intake;
whereby as air is drawn into the compressor air intake, compressor noise issuing from the compressor air intake is dampened (a) in said second acoustic chamber as only some compressor noise passes through said air holes of said silencing member, (b) by passage through said filter element from said second acoustic chamber, (c) after exiting from said filter element into said first acoustic chamber and bouncing off of said lateral enclosure of said housing, by reception by said filter element, and (d) by restricted passage through said air inlet apertures.

2. A disposable assembly as claimed in claim 1:
wherein said air inlet apertures are located laterally interior of said first acoustic chamber; and
wherein said filter assembly further includes
an air impermeable filter proximal end adjacent said housing proximal end; and
a spacer element which spaces said filter proximal end longitudinally away from said housing proximal end so as to form an air inlet chamber immediately adjacent said air inlet apertures, whereby the compressor noise is also dampened in said air inlet chamber.

3. A disposable assembly as claimed in claim 2, wherein said air inlet apertures are tuned to said inlet side of said filter element.

4. A disposable assembly as claimed in claim 1:
wherein said filter assembly further includes
an air impermeable filter distal end adjacent said housing distal end; and
a spring member located between said filter distal end and said housing distal end which (a) holds said filter assembly resiliently in place in said longitudinal housing, (b) forms a third acoustic chamber between said filter distal end and said housing distal end in which compressor noise is dampened, and (c) dampens compressor noise transmitted through said filter distal end to said housing distal end.

5. A disposable assembly as claimed in claim 1:
wherein said filter assembly includes a single said hollow filter element; and
wherein said first acoustic chamber and said second acoustic chamber are filled only with air.

6. A disposable assembly as claimed in claim 5, wherein said hollow filter element is a pleated filter.

7. A disposable assembly as claimed in claim 1, wherein said coupling member is a hollow screw nipple including a threaded section which is threadably received by the compressor air intake in order to make said longitudinal housing removable and disposable.

8. A disposable assembly as claimed in claim 1, wherein said lateral enclosure, said hollow filter element, and said silencing member all have a circular longitudinal cross section.

9. A disposable assembly as claimed in claim 1, wherein said air holes form less than 25% of a surface area of said silencing member.

10. A disposable assembly as claimed in claim 1, wherein said lateral enclosure, said housing proximal end and said housing distal end are permanently secured to one another to form a unitary longitudinal housing in which said filter assembly and said silencing member are disposed.

11. A disposable assembly for filtering air drawn into a machine air intake of an air consuming machine and for muffling noise exiting from the machine air intake, comprising:
a unitary cylindrical housing which is permanently secured together, said housing including
a cylindrical wall,
a housing proximal end which is impermeable to air and which includes air inlet apertures therethrough, and
a housing distal end which is impermeable to air;
a cylindrical filter assembly located between the proximal and distal ends of said housing, said filter assembly including
a filter proximal end adjacent said housing proximal end which is impermeable to air;
a filter distal end adjacent said housing distal end which is impermeable to air, and
a single cylindrically shaped porous filter element disposed between said filter proximal end and said filter distal end through which air is radially passed for filtering, said filter element being spaced from said cylindrical wall to form a cylindrical first acoustic chamber located radially between said filter element and said housing and filled only with air;
a cylindrical silencing member disposed along an inside radial boundary of said cylindrically shaped filter element, said silencing member
forming a second cylindrically shaped acoustic chamber interiorly thereof and filled only with air,
being impermeable to air, and
including a plurality of air apertures therein through which air radially passes from said filter element and into said second acoustical chamber;
a hollow coupling member mounted perpendicularly to the housing proximal end by which said housing is attached to the machine air intake and through which air drawn into said second acoustic chamber is then drawn into the machine air intake;
whereby as air is drawn into the machine through the machine air intake, noise issuing from the machine air intake is dampened (a) in said second acoustic chamber as only some compressor noise passes through said air holes of said silencing member, (b) by passage through said filter element from said second acoustic chamber, (c) after exiting from said filter element into said first acoustic chamber and bouncing off of said lateral enclosure of said housing, by reception by said filter element, and (d) by restricted passage through said air inlet apertures.

12. A disposable assembly as claimed in claim 11:
wherein said air inlet apertures are located laterally interior of said first acoustic chamber; and
wherein said filter assembly further includes a spacer element which spaces said filter proximal end longitudinally away from said housing proximal end so as to form an annular air inlet chamber immediately adjacent said air inlet apertures, whereby the machine noise is also dampened in said air inlet chamber.

13. A disposable assembly as claimed in claim 12, wherein said air inlet apertures are tuned to said filter element.

14. A disposable assembly as claimed in claim 12:
wherein said filter assembly further includes
an air impermeable filter distal end adjacent said housing distal end; and
a spring member located between said filter distal end and said housing distal end which (a) holds said filter assembly resiliently in place in said longitudinal housing, (b) forms a third acoustic chamber between said filter distal end and said housing distal end in which compressor noise is dampened, and (c) dampens compressor noise transmitted through said filter distal end to said housing distal end.

15. A disposable assembly as claimed in claim 14, wherein said cylindrical filter element is a pleated filter.

16. A disposable assembly as claimed in claim 14, wherein said coupling member is a hollow screw nipple including a threaded section which is threadably received by the compressor air intake in order to make said cylindrical housing removable and disposable.

17. A disposable assembly as claimed in claim 14, wherein said air holes form less than 25% of a surface area of said silencing member.

18. A disposable assembly as claimed in claim 15, wherein said air inlet apertures are tuned to said filter element.

19. A disposable assembly as claimed in claim 18, wherein said cylindrical filter element is a pleated filter.

20. A disposable assembly as claimed in claim 19, wherein said coupling member is a hollow screw nipple including a threaded section which is threadably received by the compressor air intake in order to make said cylindrical housing removable and disposable.
